(19) United States
(12) Patent Application Publication
(10) Pub. No.: US 2016/0260190 A1
(43) Pub. Date: Sep. 8, 2016

(54) PROVIDER PRICE AND QUALITY INDEX

(71) Applicant: Bill Schneider, St. Louis, MO (US)

(72) Inventor: Bill Schneider, St. Louis, MO (US)

(21) Appl. No.: 15/059,072

(22) Filed: Mar. 2, 2016

Related U.S. Application Data
(60) Provisional application No. 62/127,161, filed on Mar. 2, 2015.

(51) Int. Cl. G06Q 50/22; G06Q 10/06

(52) U.S. Cl. CPC G06Q 50/22; G06Q 10/06395

(57) ABSTRACT

Systems and methods for determining and making available to the public a quality index for health care providers based upon patient satisfaction, pricing, effectiveness, quality, outcomes, and transparency in all these and other areas. This score may be used by health care consumers to select providers and is subject to peer review by other health care providers, and to validation by comparison to publicly available data.

### CROSS-REFERENCE TO RELATED APPLICATIONS

This application claims benefit of U.S. Provisional Patent Application No. 62/127,161, filed Mar. 2, 2015, the entire disclosure of which is herein incorporated by reference.

### BACKGROUND

1. Field of the Invention

This disclosure is related to the field of health care, specifically to the evaluation of service provider price and quality.

2. Description of the Related Art

The current health care system is fundamentally flawed, with misaligned incentives and massive legislation attempting to reign in health care costs with little to no impact on insurance premiums, access to care, or improved health. At its core, rewards are tied to volume—number of patients seen and treated. It is a sickness model that reacts to disease states that have gone undetected for months and years until they require acute interventions. Because a third party—insurance company or employer—pays for the bulk of our health care expense, most consumers of health care services have little to no understanding of the costs involved, beyond direct costs to the consumer (e.g., the co-pay amount). Just as a dentist hands a child a lollipop after a checkup, the compensation system for health providers encourages over-indulgence in vice consumption: addictions, and compulsive eating, drinking, and smoking. Without all these excesses, and the chronic conditions that result, the industry would implode.

The health care consumer or patient at the center of the debate is asked to assume more responsibility for their care with the proliferation of high-deductible insurance plans. Under such plans, the consumer foots more of the bill by paying directly for some, most, or all of the cost of care until the deductible is met. With more money coming directly out of the health care consumer's pockets, the consumer naturally wants to comparison shop to evaluate costs and quality. The trouble is that providers (e.g., physician practices, hospitals or health systems) rarely, if ever, publish prices. Further, there is no easy way to objectively compare the quality of one health care provider to another. The consumer's opinion is instead formed through indirect resources, such as marketing messages, word-of-mouth, reputation, the appearance of a provider on a “top 100” list, and the like, because reliable, objective comparison data does not exist in forms that can be easily measured.

As the entire industry is entrenched in a fee-for-service model, the demographics of the aging population and the proliferation of new treatments and therapies are factors driving health care expenditures to nearly 20% of the US GDP. So, what's wrong with that? It puts employers at a disadvantage to compete internationally. General Motors spends $1,800 of every vehicle it makes on the health benefits of its workforce and retirees. Toyota, by contrast, spends $300. If all design and manufacturing efficiencies are applied to each factory, Toyota wins on price every time. State governments down to local municipalities share a similar burden with commitments made to provide health benefits to current employees and retirees. Public School systems that have historically promised health and retirement benefits are financially strained and unable to attract the best and brightest young teachers with similar benefit packages offered to their older peers. The current system is unsustainable and is headed for collapse without significant structural changes that align incentives with quality outcomes and price transparency that consumers can access and understand.

The fee-for-service mentality is so deeply rooted that many industry insiders see no way to move to a value-based delivery model. Most of us have earned such good incomes in the fee-for-service world that we don't want it to change. The idea of pay-for-prevention is counter-intuitive to a hospital that just built a bed tower of private, inpatient rooms. If you expect our communities to look out for each other in ways that keep us from ever having to go to the hospital, and the hospital is supposed to be the driver in the community that teaches healthy behaviors to prevent you from needing their services, you can appreciate the confusion. It makes no sense! But it has to start making sense for the industry to sustain itself. The health care industry has been unable to reform itself, so legislators use the heavy hand of government to move levers that they expect to change provider behaviors. Most legislators have never worked in health care and typically don't experience the same delivery system that the rest of the population has to navigate. No program has had a significant impact on moving toward value-based care. No solution has ever been sponsored by the key stakeholders in the industry, and no programs inform the consumer in meaningful ways to engage them in the debate.

Federal and state governments have proposed solutions that attempt to contain the rising costs of care and improve health only to result in a series of unintended consequences. Because a greater proportion of the expense is coming out-of-pocket, health care reform challenges consumers to become more actively engaged in their care. High deductible plans mean more self pay until deductibles are met. Most consumers have no way to evaluate the cost or quality of the options available to them. Employers large enough to self-insure bear risk for their employee populations while lacking objective data to make decisions.

So much of the industry is entrenched in the fee-for-service mentality that reform measures intend to disrupt. As we accept and embrace reform, ask what mechanisms need to be in place to achieve the triple aim of better care, improved patient experience, for the best possible price point. Health care providers must consider what matters most to informed patients who will continue to be more responsible for their care, both financially and clinically.

What is needed in the art is a way to enable the shift to a value-based model of care.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

A method for providing a normalized health care provider quality index (“PQI”) comprising: providing a computer server interfacing with a telecommunications network and comprising a central processor and a non-transitory computer-readable memory having PQI data for a plurality of health care providers, the PQI data for each health care provider comprising: an indication of a medical procedure performed by the health care provider; a patient satisfaction metric score for patients receiving the medical procedure from the health care provider; an average price charged by the health care provider to perform the medical procedure; a volume of the medical procedures performed by the health care provider; a peer benchmarking metric for the health care provider; and a geographic location for the health care provider; providing a client device interfacing with the computer server over the telecommunications network; for each health care provider in the plurality of health care providers, calculating a PQI score for the health care provider to provide the medical procedure indicated in the PQI data, the PQI score being calculated based upon the PQI data for the health care provider; receiving at the computer server updated PQI data for at least one health care provider in the plurality of health care providers and recalculating the PQI score for the health care provider based on the updated PQI data; the client device transmitting to the server a score request including a client geographic location; in response to the received score request, the computer server selecting from the plurality of health care providers those health care providers having an indicated geographic location within a predetermined distance from the client geographic location; the computer server sending to the client device data including the selected health care providers and the determined PQI score for each one of the selected health care providers, and the geographic location for each one of the selected health care providers; and the client device displaying the received plurality of selected health care providers and the provider quality index for each one of the selected health care providers.

In an embodiment, the patient satisfaction metric score comprises data from a consumer assessment survey received at the computer server from a third party computer server.

In another embodiment, the consumer assessment survey is a post-discharge satisfaction survey.

In another embodiment, the average price comprises the average price charged by the health care provider to perform the medical procedure during a pre-determined period of time.

In another embodiment, the average price comprises the average price charged by the health care provider to perform a pre-determined number of most recent procedures.

In another embodiment, the average price comprises the average price charged by the health care provider to perform the 50 most recent procedures.

In another embodiment, the average price is based upon chargemaster data received at the computer server from a third party computer server.

In another embodiment, the provider quality index score is normalized on a scale of 1 to 100.

In another embodiment, the updated PQI data is received at regular intervals.

In another embodiment, the regular interval is monthly.

In another embodiment, the provider quality index determination for a health care provider increases if the health care provider provides at the computer server the PQI data for the health care provider regardless.

In another embodiment, the PQI data further comprises medication adherence data.

In another embodiment, the PQI data further comprises employee satisfaction data.

In another embodiment, the provider quality index determination weights procedure volume most heavily.

In another embodiment, the peer benchmarking metric is provided at the computer server by a third party peer organization server.

In another embodiment, the third party peer organization is in the same geographic region as the health care provider.

In another embodiment, the method further comprises displaying on the client device the geographic location for each one of the selected health care providers.

### BRIEF DESCRIPTION OF THE DRAWINGS

FIG. 1 depicts a diagram of one embodiment of a system method for determining and providing a provider quality index value.

FIG. 2 depicts a diagram of a weighting scheme for a provider quality index in an embodiment.

FIG. 3 depicts an alternative diagram of a weighting scheme for a provider quality index in an embodiment.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

The Provider Price & Quality Index (“PQI”) is a cloud-based information system, database and algorithms for health care providers to calculate a score based on patient satisfaction, pricing, effectiveness in communication, efficiency in practice, quality measures, outcomes, continuous improvements, and transparency in all the above areas. This Index is then used by health care consumers to select providers while assuming greater responsibility for health care by being able to better assess value in making these decisions. The Index is also used by payers to align incentives and reward desirable behaviors. Other stakeholders will also benefit from having a standard set of metrics by which to negotiate compensation, allocate bundled payments, reward efficient behaviors, and prove effectiveness. With appropriate collaboration, the Index can become the basis for a prevention-based model of care.

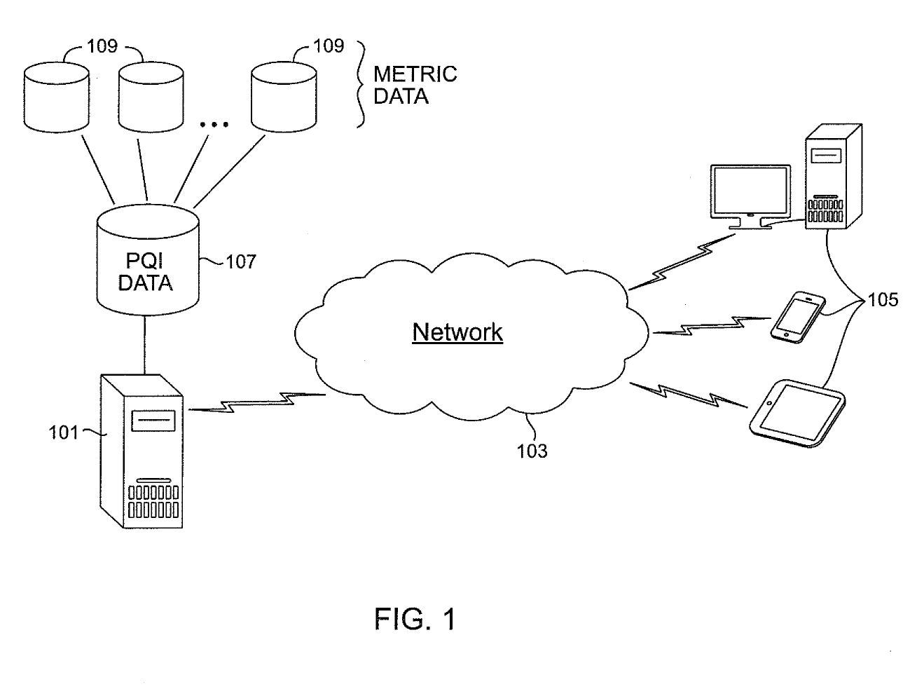

An embodiment of a system for determining and displaying or providing a PQI is depicted in FIG. 1. In the depicted embodiment, one or more client devices (105) access a server (101) over a network (103). The server (101) generally performs the operations described herein, in terms of both backend/batch processing, and responding to client (105) requests. The server (101) is communicably connected to a PQI database (107), which has PQI data for a plurality of providers. The PQI database (107) is populated based at least in part upon metric data (109) from a plurality of external, or third party, sources. The client device (105) will typically be a computing device having thereon a web user-agent or other software with similar functionality.

As used here, the terms Provider shall mean a provider of health care services, including both facilities and individuals such as, but not necessarily limited to: hospitals; emergency rooms; urgent care centers; nursing, elder, disabled, and specialty care facilities; hospice; clinics; primary care physicians; public and/or community clinics; physician's offices; dentists; pharmacies; midwives; dietitians; therapists; psychologists; psychiatrists; chiropractors; phlebotomists; audiologists; pediatrics; optometrists; speech pathologists; EMTs; paramedics; medical laboratories; prosthetics; radiology; social workers; orthodontics; nursing centers; occupational therapists; physical therapists; behavioral therapists; physicians; nurses; and, any other form of health care service provider. Although the system and methods described herein generally contemplate health care services provided to humans, they are applicable to other health care services, including but not limited to veterinary medicine. More generally, the systems and methods described herein may be suited for use in other contexts.

The systems and methods described herein are generally implemented in a client-server architecture, with certain preprocessing conducted to set up the system. This preprocessing generally includes creating a PQI database for handling PQI requests. The client is typically implemented as a software application on a user device carried by the consumer, or as a web user-agent. The user device may be, but is not limited to, a smart phone, tablet PC, e-reader device, wearable technology, or any other type of mobile device capable of executing the described functions. Generally speaking, the user device is network-enabled and communicating with the server system over a network.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wristwear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including, without limitation, onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, terms used herein to describe or reference media holding software, including without limitation terms such as “media,” “storage media,” and “memory,” refer to computer- or machine-readable digital storage media, regardless of the storage means (e.g., magnetic storage, optical storage, etc.), and may include or exclude transitory media such as signals and carrier waves.

Throughout this disclosure, the terms “web,” “web site,” “web server,” “web client,” and “web browser” refer generally to computers programmed to communicate (or the programming itself, as the case may be) over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests (or the software on such a computer doing same), and a “web client” is a computer having a user agent sending and receiving responses to HTTP requests (or the user agent itself). The user agent is generally web browser software.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

The systems and methods described herein generally use computer technology to implement a rating system for providers, referred to herein as a Provider Price & Quality Index, or “PQI.” Generally, a cloud-based system collects and/or stores pricing, performance, and quality/outcomes data from a plurality of health care providers and calculates or generates a PQI for each such provider. Generally, the PQI is a discrete number on a scale of 1-100, with 100 being the best possible value an organization can attain.

A PQI may be calculated by considering, at least in part, one or more of the following metrics pertaining to the Provider: patient satisfaction; employee satisfaction; price; one or more quality measures, generally based on care setting and Provider type; volume defined as the number of patient interactions; medication adherence; benchmarks that compare providers against their peers; and incremental changes in Index Value. Various data sources, which can be indicator of these and other measures, may be created, updated, edited, altered, stored, and accessed in determining and/or providing the PQI for a particular Provider.

In an embodiment, patient satisfaction data comprises data from a third party survey, such as, but not necessarily limited to, the Hospital Consumer Assessment of Healthcare Providers and Systems (HCAHPS) survey. Patient satisfaction scores may additionally or alternatively be derived from data sources such as, without limitation, Press Ganey and/or NRC Picker, and others that collect and report post-discharge satisfaction survey data. These data sources are considered reliable indicators by facilities themselves, and their extended networks of employed providers, and many adjust compensation models based, at least in part, upon data provided by these data sources. Larger health systems may also, or alternatively, track employee satisfaction and generate scores (i.e., data) indicative of same. Employee satisfaction data may not always be included in a particular PQI evaluation, as not all facilities and/or health care systems generate usable data. For example, such data may not be objectively gathered or reported, may not be made available, or may not be in a format or structure conducive of normalization and/or standardization. As described below with respect to factor weighting, where usable employee satisfaction data is not available, the weight of the patient satisfaction metric may be increased relative to other metrics, such as by doubling.

In an embodiment, pricing data comprises facility-specific pricing data, such as, but not limited to, chargemaster records. Chargemasters, sometimes also called charge description masters (“CDM”), are known in the art to be a comprehensive listing of items billable to a patient or insurer. Each facility or health care system generally creates and/or maintains its own independent CDM, which includes data describing hundreds, and sometimes thousands, of hospital services, medical procedures, costs, fees, pharmaceutical products, supplies, equipment costs, diagnostic costs and tests, and other billable items. Typically, each billable item in a CDM has an assigned unique identifier or code, and a set price. A CDM may be used in negotiations with insurance companies and may be stored, in various forms or formats, in patient billing/revenue cycle software, databases, and/or applications. It is used in negotiating managed care contracts with payer organizations and self-insured employers. CDMs are also known to have inflated prices, as they are often used as the starting point for price negotiations with insurers. Organizations in certain markets already publish their prices for the various procedures and the impact is significant on competitors in the market.

When used as a data source in calculating the PQI, CDM prices may be adjusted. By way of example and not limitation, a standard discount percentage may be applied. In an alternative embodiment, the facility may publish or otherwise provide or make available an adjusted CDM with prices normalized on a standardized scale. For example, the scale may be undiscounted price, or a fixed discount price, or the hospital's discounted price for cash payers at the point-of-care.

Not all billable items in a chargemaster are necessarily indicative of the quality of care. As such, in an embodiment, not all billable items in a chargemaster are used in calculating the PQI. Generally, the PQI calculation considers procedures performed frequently at the facility. By way of example and not limitation, the PQI may only consider the price of the fifty most frequently performed procedures at the facility over some fixed period of time. In the preferred embodiment, a Provider receives full credit for meeting the price metric if the Provider publishes or otherwise makes available pricing data on its most frequently performed procedures.

In an embodiment, transparency is generally weighted more heavily than price. For example, whether a total knee replacement costs $2,500 or $25,000, the price does not necessarily impact score. Rather, merely by publishing the current cash price for the 50 most common procedures performed, a provider may receive a full 20 points for meeting the transparency metric. By publishing the current cash price, the system introduces another opportunity for providers to show willingness to work with self-pay and private patient populations outside the realm of third-party payers. Elsewhere in the calculation of the index, actual prices may be compared against the others in the same peer group. This benchmarking may not carry the weight or significance as does pricing transparency and quality, but may impact your score.

In an embodiment, medication adherence data comprises pharmaceutical benefit management data. Pharmaceutical benefit management firms, or “PBMs,” may implement patient compliance programs to encourage medication adherence, and may have patient compliance databases. Because medications are prescribed by individuals (e.g., physicians, physician assistants, nurse practitioners, etc.), and not facilities, this metric is generally used in PQI calculations for individuals who are providers. Medication adherence data may include, among other things, consumption rate, refills rate, and prescriber data.

In an embodiment, quality metric data comprises third party quality reporting data. Such data may be, without limitation, data acquired, collected, and/or reported by governmental agencies and/or via governmental programs that require or include quality reporting. Generally, quality metric data comprises data about a particular care environment, location, or setting, as quality metrics may vary from hospital to hospital, and from Provider to Provider, depending upon subjective criteria as to what constitutes “quality” of care for a given population of patients. By way of example and not limitation, patients using a rural health clinic may prioritize different quality measures than patients in a suburban urgent care center.

In another embodiment, physician membership organizations may identify the appropriate quality measures, such as by polling their members to reach consensus or agreement on the top few measures that should be included in the PQI for a particular care environment. This allows providers with experience and familiarity with a given practice or specialty (or sub-practice or sub-specialty) to submit the top quality measures for that practice or specialty. Such physician groups may also modify the measures on a periodic basis to reflect advances in medical science and shifts in patient priorities.

By way of example and not limitation, modern radiology practices emphasize appropriateness of the diagnostic test and exposure to radiation as quality measures. As decision support tools evolve, radiologists may deem that these considerations fall from the top priorities and should be replaced by other quality measures. Radiologists are well-suited to know quality in radiology and can collectively inform the PQI for that specialty. By placing the identification of these measures in the hands of providers, those who directly serve patients, and thus know how patients perceive quality, are in a preferred position to define the metrics. This further facilitates the implementation of a value-based care model.

In an embodiment, volume is indicative of quality and incorporated into the PQI. By way of example and not limitation, if a given provider sees fifty patients per day and an alternative provider sees only five, the former provider will likely have higher patient satisfaction scores, as evidenced by the repeat business and higher volume. However, excess patient loads can also impact clinical outcomes and patient satisfaction. As a result, the impact of volume data on PQI is not necessarily linear; that is, in certain embodiments, there may be a point of diminishing returns as volume increases. In one exemplary embodiment, this is implemented by dividing the peer group volumes into quintiles and awarding points based on a progression. An example of such a progression is: 2, 4, 6, 8, 6; i.e., as the volume reaches certain thresholds or milestones, the number of points assigned for that volume begins to decline, corresponding with a decreased efficacy of treatment due to excess volume.

An example would be primary care physicians in a group practice. Suppose a group of 3 providers see 100 patients a day on average. Provider A sees 10, Provider B sees 30, and Provider C sees 60, all of the same acuity and all requiring the same amount of time to enter data into the electronic record. It is not equitable to divide the revenue equally, nor is it appropriate to compensate based on patient satisfaction as Provider A spends far more time with each patient. Provider C is so rushed that she flies through the appointments, bills twice the revenue as B, but leaves her patients feeling like she didn't listen attentively or care enough. The volume metric attempts to strike the right balance of efficiency among all the tasks involved in patient care, preparation, follow up, research, charting, responding to emails from patients and family members, etc.

Volume is a particularly useful metric because research has shown that hospitals which specialize in a particular area deliver better outcomes at significantly reduced costs. By way of example and not limitation, heart hospitals drive large volumes and tend to excel at cardiac procedures. Also by way of example and not limitation, hospitals with high birth rates tend to have processes, staff, and mechanisms in place to increase or maximize efficiencies and deliver better outcomes, while lowering or minimizing cost, as compared to a hospital with fewer deliveries. Also by way of example and not limitation, there is often a direct correlation between productive radiologists and radiology accuracy. Similar results have been observed with ENTs who perform thousands of ear tube procedures.

In an embodiment, benchmarking among peers is incorporated into a PQI. Peer benchmarking is important because, among other things, quality is relative. By way of example and not limitation, there may be extreme variations in acuity levels and overhead structures as between academic medical centers as compared to rural community/critical access hospitals, free-standing imaging centers, or ambulatory surgery centers. Thus, it is preferred that benchmarking is conducted by peer organizations in the same region.

In an embodiment, peer benchmarking comprises separating into a plurality of peer groups. This is due, in part, to the variations in acuity levels and overhead structures seen in the range from academic medical centers to rural community/critical access hospitals to free-standing imaging centers to ambulatory surgery centers. If peers exist in a region, the PQI may provide a method for stakeholder organizations to compare the top-six metrics and calculate score.

In an embodiment, a plurality of provider peer groups is defined for purposes of benchmarking. Providers may be categorized into at least one such peer group. In one exemplary embodiment, nine peer groups are defined as follows: clinics with five or fewer physicians; group practices with six or more physicians; ambulatory surgery centers; outpatient imaging centers; federally-qualified health centers; rural health clinics; critical access hospitals; community hospitals; and academic medical centers.

In an embodiment, one or more quality metrics is used to calculate a PQI for a Provider. There are limitless methods for blending and combining these measures. In one embodiment, each metric is worth a pre-defined maximum number of points. In such an embodiment, the sum of the points for all considered metrics is one hundred. The amount of such points earned by the Provider is determined for each metric, and summed, to arrive at the PQI.

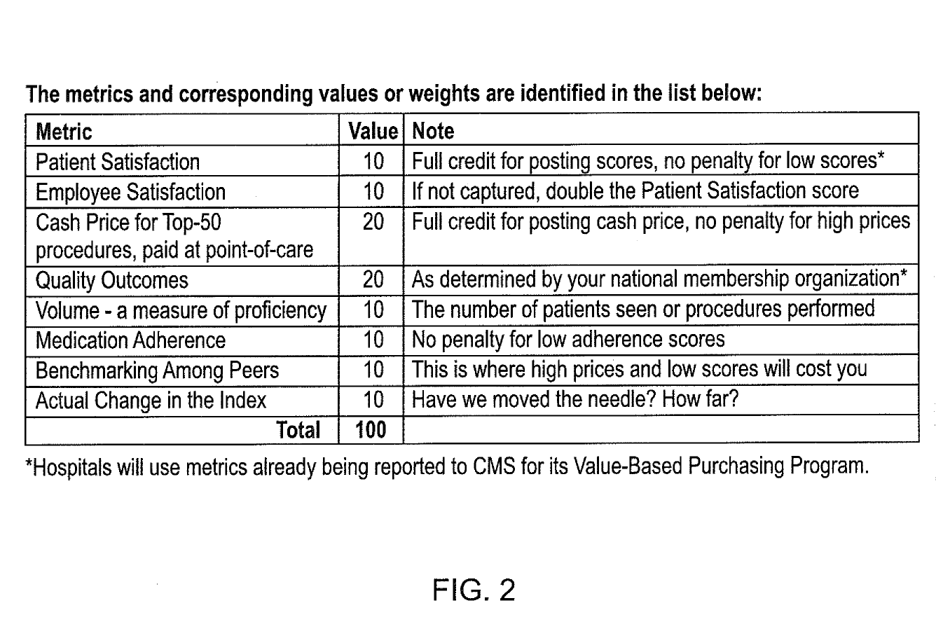

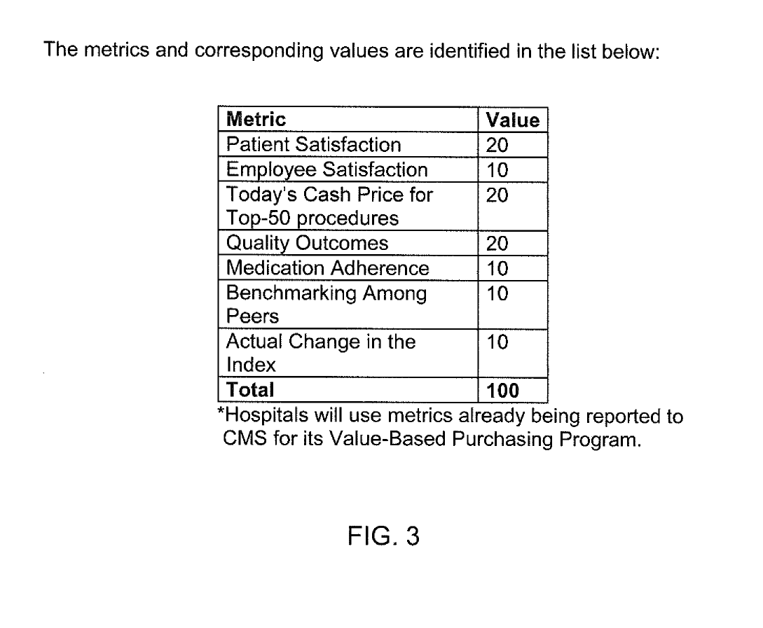

In an alternative embodiment, the metrics may be weighted. Exemplary embodiments of such weighting are depicted in FIG. 2 and FIG. 3.

PQI results and/or calculations may be provided via a web site interface. The web site may have a unique page or landing page for each Provider for which PQI calculations are available. Because at least some of the metrics are based upon transparency, in at least some embodiments, providers generally can achieve relatively high scores, regardless of price or quality of care, simply by providing data.

Collection of the data for each metric, and the calculation of the index generally occurs at a regular interval, such as monthly. Typically, data is collected during the initial portion of a collection cycle (e.g., the first five days of the collection month). The data is then processed and analyzed, and displayed on the web page for the Provider. This allows processing time to derive the benchmark among peers and incremental gain or loss from the prior month. A link or other navigation component may be provided to direct users to the three (3) data entry pages that were uploaded and used to calculate the index. The index may be embedded or included in a Provider's own web site, where it will be automatically updated month-over-month, and/or may be included in publicly available resources, including but not limited to: Healthgrades.com, CMS.gov, ConsumerReports.org, AngiesList.com, and/or HospitalCompare, as examples.

While certain portions of the PQI are not computationally intensive, others require the accumulation, aggregation, and analysis of data from various sources. For example, benchmarking among peers, in each of the nine (9) groups, and incremental gain/loss are generally processed in back-end servers dedicated to processing the monthly inputs in a private cloud configuration.

As the Continuous Quality Improvement (CQI) programs use five tiers each worth 20% or two points of this metric category, the amount of change relative to peers in a region would be calculated the same way. Suppose three hospitals in a market all modify their Index score in a given month. Facility A improves its score by 5 points, facility B by 2 points, and facility C actually drops a point. Facility A would capture the maximum 10 points for having a greater gain than all others. Facility B would capture 8 out of 10 points for showing the second largest gain. Facility C would still receive 2 points for providing the required transparency and link to the data despite having dropped by one.

Top performers will quickly learn that it is virtually impossible to achieve a perfect PQI score of 100. As you progress into the nineties, you can see each incremental point gain gets exponentially more difficult to achieve.

Providers should update their Index by the fifth day of the following month and allow 2 days for PQI staff to incorporate the last two metrics into their score (i.e., the Benchmarking score and the Actual Change in Value score) to compute a new Index for the coming month. Posts to a public forum for challenging or commenting on a metric can happen at any time during the month.

Just as more quality measures are added every year to CMS's Hospital Value-Based Purchasing program, the Index must remain flexible enough to apply more or less weight to each of the metrics that comprise the Index. Likewise, it must allow for entire categories to be missed and still generate a meaningful score on a 100-point scale. For example, a hospital will not prescribe medications, only the hospitalists and physicians that serve patients in those settings do so. Thus, a hospital may not have a Medication Adherence score. In such circumstances, the 10 points for Medication Adherence may be applied or distributed to other measures or metrics, such as the Clinical Process of Care/CQI measures in place.

For the Index to serve many stakeholders, it has to be flexible, easy-to-use, and powerful enough to capture the relevant metrics in a score. Generally, full credit is accumulated in the first six categories above (80%) by posting the Index on the home page of a provider organization's website. A PQI logo, or medallion containing the Index in the lower right-hand corner of the page will also be a hyperlink to the Supporting Details pages that reveals exactly how the Index was calculated. Publishing this information on a provider or provider organization's website is an important first step toward the transparency required for patients to become engaged in their care. This information and links to it, updated monthly, along with links to it, is preferably available in at least three places: (1) accessible on the main page or splash page of the provider organization's website; (2) available as downloadable data presented in a standard format consistent among all provider groups; and (3) via consumer advocacy organizations, such as HealthGrades, Consumer Reports, Angie's List, HospitalCompare, UcompareHealth, or another objective third-party reporting service.

The Index will use data that is already being reported to CMS and state agencies and will evolve to include the metrics added as these programs evolve. Examples include: Medicare's Value-Based Purchasing Program for Hospitals; Patient-Centered Medical Homes; Rural Health Clinics and Federally Qualified Health Centers; Federal and State Mortality and Morbidity Reporting Requirements.

The Provider Price & Quality Index delivers the transparency that has been missing in the delivery of health care services. The first 80 points should be awarded at full value for achieving acceptable transparency. By simply displaying the PQI with a link to the web page that contains tables and supporting details revealing actual patient satisfaction scores, today's cash prices, medication adherence, clinical quality, readmission rates, and all the metrics used to calculate the index will be available for anyone with a basic reading level to access. The PQI navigation element on the organization's main website home page is hyperlinked to the transparency window containing the actual data. This clear and factual presentation of data is not meant to be weighed against the Provider, nor benchmarked within the region or peer group, yet. Thus, if a patient or consumer wants to see the cash price for the top 50 procedures performed by that Provider, he or she could click through to access the actual pages that were used to update the PQI for the current month.

Consistent with a market-driven approach, reporting will rely on the honor system and the intense scrutiny of competitors and health care consumers, including large employer groups that are active in the marketplace. Since the Index value and the supporting details are readily available, anyone in the market can see the calculations used to arrive at the score. Competitors in the market will continually review each other's data used to calculate the Index and report discrepancies. Payer organizations and CMS also have a vested interest in the various Index values when their payments are tied to a provider's score. LinkedIn, or another social media site may host a forum to report discrepancies. Provider Price & Quality Index staff can investigate complaints, request explanation from the offending party, give 30 days to correct, and publicly penalize the offender.

Since most of what is being presented and used to calculate the Transparency portion of the Index is also being reported to state and federal agencies, discrepancies may result in a “yellow card” on the PQI navigation element and subsequent transparency pages of the organization's PQI homepage. Continued discrepancies may result in a “red card” and show the discrepancies in a details page. This should be understood as a black mark, equivalent to a professional athlete testing positive for performance-enhancing drugs. The Index is refreshed monthly. The yellow and red shading would appear in 3 sizes—largest for the first month following the discrepancy, reduced down to the next size for the second month, and to its smallest size for the third month. Competitors in the market may be relied upon to report discrepancies, and some may even employ a small staff to investigate and enforce the penalties.

While the invention has been disclosed in conjunction with a description of certain embodiments, including those that are currently believed to be preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for providing a normalized health care provider quality index (“PQI”) comprising:
providing a computer server interfacing with a telecommunications network and comprising a central processor and a non-transitory computer-readable memory having PQI data for a plurality of health care providers, said PQI data for each health care provider comprising:
an indication of a medical procedure performed by said health care provider;
a patient satisfaction metric score for patients receiving said medical procedure from said health care provider ;
an average price charged by said health care provider to perform said medical procedure;
a volume of said medical procedures performed by said health care provider;
a peer benchmarking metric for said health care provider; and
a geographic location for said health care provider;
providing a client device interfacing with said computer server over said telecommunications network;
for each health care provider in said plurality of health care providers, calculating a PQI score for said health care provider to provide said medical procedure indicated in said PQI data, said PQI score being calculated based upon said PQI data for said health care provider;
receiving at said computer server updated PQI data for at least one health care provider in said plurality of health care providers and recalculating said PQI score for said health care provider based on said updated PQI data;
said client device transmitting to said server a score request including a client geographic location;
in response to said received score request, said computer server selecting from said plurality of health care providers those health care providers having an indicated geographic location within a predetermined distance from said client geographic location;
said computer server sending to said client device data including said selected health care providers and said determined PQI score for each one of said selected health care providers, and said geographic location for each one of said selected health care providers; and
said client device displaying said received plurality of selected health care providers and said provider quality index for each one of said selected health care providers.

2. The method of claim 1, wherein said a patient satisfaction metric score comprises data from a consumer assessment survey received at said computer server from a third party computer server.

3. The method of claim 2, wherein said consumer assessment survey is a post-discharge satisfaction survey.

4. The method of claim 1, wherein said average price comprises the average price charged by said health care provider to perform said medical procedure during a pre-determined period of time.

5. The method of claim 1, wherein said average price comprises the average price charged by said health care provider to perform a pre-determined number of most recent procedures.

6. The method of claim 5, wherein said average price comprises the average price charged by said health care provider to perform the 50 most recent procedures.

7. The method of claim 1, wherein said average price is based upon chargemaster data received at said computer server from a third party computer server.

8. The method of claim 1, wherein said provider quality index score is normalized on a scale of 1 to 100.

9. The method of claim 1, wherein said updated PQI data is received at regular intervals.

10. The method of claim 9, wherein said regular interval is monthly.

11. The method of claim 1, wherein said provider quality index determination for a health care provider increases if said health care provider provides at said computer server said PQI data for said health care provider regardless.

12. The method of claim 1, wherein said PQI data further comprises medication adherence data.

13. The method of claim 1, wherein said PQI data further comprises employee satisfaction data.

14. The method of claim 1, wherein said provider quality index determination weights procedure volume most heavily.

15. The method of claim 1, wherein said peer benchmarking metric is provided at said computer server by a third party peer organization server.

16. The method of claim 15, wherein said third party peer organization is in the same geographic region as said health care provider.

17. The method of claim 1, further comprising displaying on said client device said geographic location for each one of said selected health care providers.
